(19) United States
(12) Patent Application Publication
(10) Pub. No.: US 2010/0033750 A1
(43) Pub. Date: Feb. 11, 2010

(54) Method and Apparatus for Detecting an Inconsistency in Dual Sided Printing

(75) Inventors: Shmulik Tischler, Ness Zionna (IL); Yaron Hershman, Gedera (IL); Uri Glas, Vancouver, WA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/440,678

(22) PCT Filed: Sep. 27, 2006
(86) PCT No.: PCT/US06/37610

§ 371 Date: Oct. 1, 2009

(51) Int. Cl. G06K 15/02

(52) U.S. Cl. 358/1.14

(57) ABSTRACT

A dual engine printer comprises two print engines, and identical spread data is forwarded to each of the print engines, although each engine prints only one side of the sheet. Each print engine comprises a signature extractor for extracting a signature representative of the spread data it receives, and the printer is able to compare the two signatures to verify that the spread data is identical. The printer is thus able to detect data corruption or alternatively, if the signature extraction is synchronized with the print engage, the printer can verify that both sides are being printed on the same sheet.

### BACKGROUND OF THE INVENTION

The present invention relates to a method and apparatus for detecting an inconsistency in dual sided printing.

Dual engine printers are printers that have two printing engines or sets of drums for printing. Dual engine printers are useful for double sided, or duplex, printing, such that one side of a printing substrate, or sheet is printed using one engine and then the sheet is passed on to the second engine for printing on the second side.

Previous proposals for dual engine printers have communications between the first and second printing engines. The master controller of the printing machine sends the print instructions for a full duplex page to separate slave controllers of the individual print engines. Once side A has been printed at the first print engine the sheet is flipped, and travels towards the second print engine, which it reaches several print cycles later, depending on the size, speed and setup of the printer. A connection between the two print engines allows print engage at the two engines to begin at the same time so as to smooth the passage of sheets between the two engines.

As a further issue the two engines need to be sufficiently coordinated so that the second side of a sheet is printed on the correct sheet. That is to say, the situation must be prevented wherein sides belonging to two different sheets or spreads are printed on different sides of the same sheet.

Many scenarios exist that can cause an inconsistency in the data or the print order at a point following printing of side A and before the sheet reaches the second print engine for the printing of side B. The second print engine only has basic timing information and does not actually know which sheet is currently present. Therefore print disorders may occur wherein the two sides of a given printed sheet output do not correspond. Such a condition is referred to hereinafter as print disorder, and a print disorder of this sort may propagate throughout the entire print job. When a disorder occurs in a dual printing job, often it is not noticed until the final product arrives at the customer.

U.S. Pat. No. 5,710,635 discloses a general purpose scheduling algorithm for a dual engine printer. It is applicable to situations having double sided and color printing. However, it does not solve specifically the above problem of the spreads of two different sheets being printed at the second of two engines in a dual engine print machine.

U.S. Pat. No. 6,259,884 teaches a complex system for duplex printing which allows for improved printing efficiency. However, the system taught suffers from undue complexity and certainly does not solve the above problem of print disorder in a dual print machine.

There is thus a widely recognized need for, and it would be highly advantageous to have, a dual engine printing system devoid of the above limitations

### SUMMARY OF THE INVENTION

According to one aspect of the present invention there is provided, a dual engine printer comprising a first print engine and a second print engine, wherein identical spread data is forwarded to each of said print engines, each print engine comprising a signature extractor for extracting a signature representative of at least part of said spread data, said apparatus being configured to compare said signatures to output a verification result to verify that at least part of said spread data is identical.

In a dual engine printer having a first print engine and a second print engine, each engine printing respective sides of a plurality of sheets in dual sided printing where print data of both sides of said sheets is received at both engines, there is provided a method for detecting an inconsistency between printing at said first print engine and at said second print engine, the method comprising:
generating first identification data from said print data for a respective sheet in association with said first print engine,

independently generating second identification data from said print data for a respective sheet in association with said second print engine, and
at a time of presumed printing of said respective sheet at said second print engine, comparing said first identification data with said independently generated second identification data to verify that a second side is being printed on said respective sheet.

In a dual engine color printer having a first print engine and a second print engine, each engine printing respective sides of a plurality of sheets in dual sided printing where print data of both sides of said sheets is received at both engines, there is provided an apparatus for detecting an inconsistency between printing at said first print engine and at said second print engine, the apparatus comprising:
a processor for generating first identification data from said print data for a respective sheet in association with said first print engine,

a processor for independently generating second identification data from said print data for a respective sheet in association with said second print engine,
a device in association with said second print engine for comparing said first identification data with said independently generated second identification data to verify that a second side is being printed on said respective sheet.

According to a further aspect of the present invention there is provided a method for dual sided printing using first and second print engines for printing of respective sides of a dual sided sheet, print data for both sides of said sheets being received at engine, said print data comprising a plurality of print elements, the method comprising:
independently generating at each engine respective identification data for said print elements
comparing said respective identification data of corresponding said print elements; and
resending any element found not to be identically received at both engines.

According to a further aspect of the present invention there is provided an apparatus for dual sided printing using first and second print engines for printing of respective sides of a dual sided sheet, print data for both sides of said sheets received at each engine, said print data comprising a plurality of print elements, the apparatus comprising:
processor for generating at each engine respective identification data for said print elements;
a comparison device for comparing said respective identification data of corresponding said print elements; and
a master controller for resending to at least one of said engines any element found not to have been identically received at both engines.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic view of a first embodiment of the present invention.

FIG. 2 is a more detailed view of the embodiment of FIG. 1.

FIG. 3 is a simplified block diagram showing an alternative version of the view of FIG. 2.

FIG. 4 is a simplified flow chart illustrating a print process of a particular embodiment of the present invention.

FIG. 5 is a simplified flow chart illustrating the main steps in a print performed at the first print engine according to an embodiment of the present invention.

FIG. 6 is a simplified flow chart illustrating the main steps in a print performed at the second print engine according an embodiment of the present invention.

FIG. 7 is a table illustrating a correct print on both sides of the sheet.

FIG. 8 is a modification of the alignment situation of FIG. 7 showing the case where a sheet disorder or other error occurs between engines.

FIG. 9 is a drawing showing the different data elements on a sheet.

FIG. 10 is a schematic view of a particular embodiment of the present invention.

FIG. 11 is a simplified flow chart showing the print process for FIG. 10.

FIG. 12 shows a system overview of a particular embodiment of the present invention.

### DETAILED DESCRIPTION OF THE PREFERRED EMBODIMENT

The present embodiments relate to a dual engine printer carrying out dual sided printing. A number of print cycles separate the two print engines so that synchronization between the engines is necessary in order to ensure that the second side of a given printing spread is actually printed on the correct sheet. Synchronization between the engines is sufficient most of the time, but occasionally fails, say during the case of a page slip, a temporary halt to the printer or the like. Should such a failure occur then a given sheet is likely to complete the printing process with different sides relating to different spreads, a situation known as print disorder. The print disorder error is likely to propagate throughout the current print job, and thus needs to be caught or trapped.

There are numerous solutions that solve different causes of print disorder. There is however no solution that is universal, that is to say that simply spots that a print disorder has occurred, irrespective of the cause. Such a universal solution is useful say for users who do not have regular access to service engineers.

The present embodiments thus provide a print disorder trapper which is designed to identify the occurrence of a print disorder error and notify the operator and/or stop printing so that propagation does not occur. Preferably the trapper operates irrespective of the cause of the error.

The trapper takes advantage of the fact that a single print file is prepared by the print controlling computer for both sides of the spread, and that single file is sent to both print engines. The two engines can thus compare data between them to ensure that the second engine is printing the same spread that the first engine was printing when it had the current sheet.

The trapper further takes advantage of the two engines being directly connected via a data link. The data link is of low capacity so the full print file is not exchanged but a unique signature of the data, such as a checksum may be.

In a further aspect of the present invention the data link and the signatures are used to detect and additionally to correct data corruption within the print file. In this aspect the print file encodes different elements of the print data as separate units. The two engines simply use the data link to compare signatures of the data elements to know whether they are the same or not. In this case the signatures may merely be header information of the data units, although checksums could be used instead. In this aspect, in the event of an inconsistency being found for a particular data element, the master can be queried as to which of the signatures is correct and a correct version of the unit can be resent.

The principles and operation of an inconsistency detecting apparatus and method in dual sided printers according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

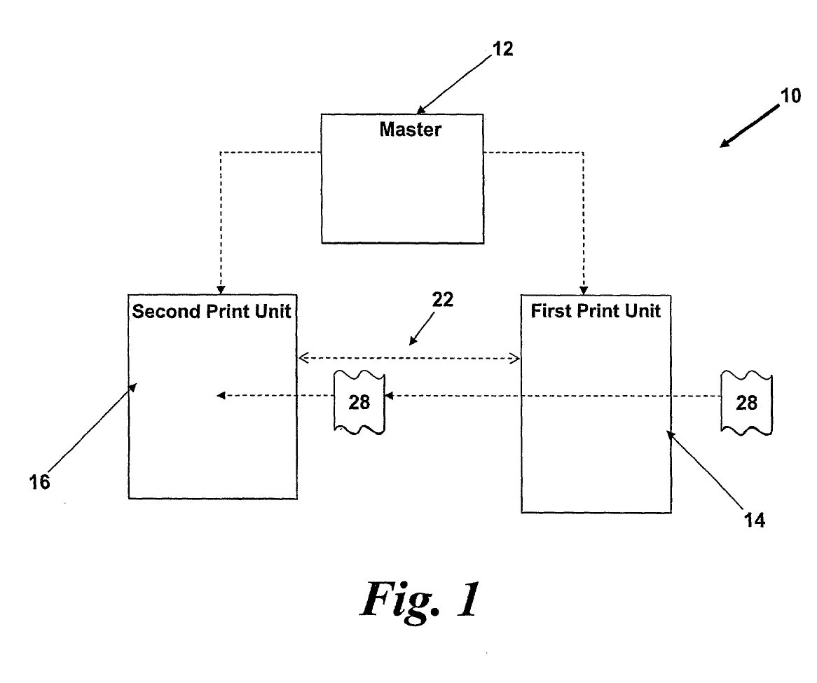

Reference is now made to FIG. 1, which is a schematic view of a first embodiment of the present invention. A dual engine printer 10 comprises a master print unit 12 which sends print instructions to two individual print units 14 and 16. The two print units are connected by communications link 22. The basic operation of the dual engine printer is as follows. A sheet 28 enters first print unit 14. The master sends to both print units the entire “spread” or print data to be printed on both sides of the incoming sheet. That is to say, data for both sides of the sheet is sent to both units in advance even though only one side is actually printed at each unit. Once the spread data is received by the print units, both the first and second print unit independently calculates print identification data, for example a checksum, from the spread data. The checksum at the first print unit is then sent to the second print unit through communications channel 22 and is stored in a buffer therein. The checksum computed at the second print unit is stored in a separate buffer therein as well.

The first print unit then uses the spread data to print side A of the sheet, while the second print unit buffers the spread data until the same sheet arrives at the second print unit. After the print on side A is finished, the sheet is preferably inverted and now travels towards the second print-unit, which it reaches several print cycles later to print side B.

The data link between the two print units is of low capacity, and therefore the entire print file for each sheet is not sent for, comparison, but only print identification data, as explained above. On the other hand, merely sending to the second print unit say the job and spread number for a given sheet does not give any indication of the data actually printed on the sheets. The embodiments of the present invention provide a universal solution to ensure that a print disorder is trapped or data corruption is identified irrespective of the cause.

The checksum received from the first print unit is stored in a stack at the second print unit. Alternatively, the checksum is stored in a buffer such as a forecast array buffer. After several cycles, the sheet arrives at second print unit 16 for side B printing. The reason for multiple cycles during the time interval between the printing of side A and side B include the following. First, while the paper is traveling across the print machine from the first to the second print unit, side A needs to dry. Secondly, the physical size of print units and feeder systems, and the need to turn over the sheet, all lead to the necessity for a certain distance through which each sheet must travel. The most efficient way to send sheets through that distance without slowing the printing is to allocate print cycles, so that the second machine does not have to wait.

When a sheet arrives at the second print unit 16, a comparison is made between the print identification data received earlier from the first print unit and the print identification data computed independently at the second print unit. As mentioned, each set of print identification data is stored in a separate buffer, such as a forecast array buffer, at the second print unit. Alternatively, the checksums are stored in stacks thereupon.

Again, a comparison of the two buffered checksums is carried out at the second print unit. If the two checksums are not identical, an inference is made that a print disorder has occurred. The printing is stopped prior to print engage and the machine operator is notified. The print disorder is successfully trapped.

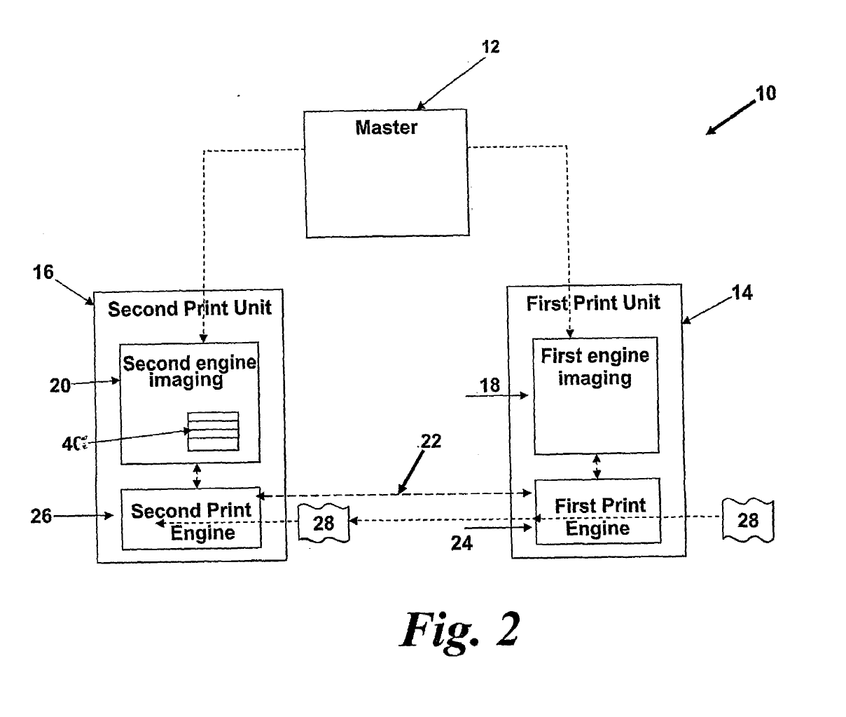

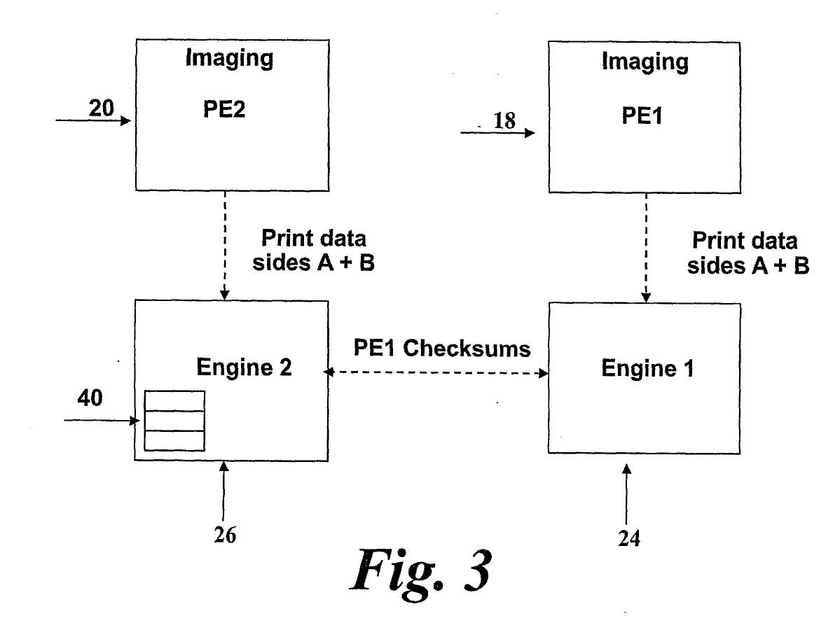

We now refer to FIG. 2, which shows a particular and more detailed view of the printer of FIG. 1. Parts that are the same as in FIG. 1 are given the same reference numerals and are not referred to again except as necessary for an understanding of the present embodiments. Each print unit contains an engine controller or imaging unit connected to the corresponding print engine. The imaging unit is used for such functions as storing the print data received from the master, passing the relevant spread data to the print engines, and computing and/or storing the print identification data. It is appreciated that in alternative embodiments, such as seen in FIG. 3, the print identification data is computed and/or stored at the print engines themselves. The first print unit contains engine imaging unit 18 that feeds first print engine 24. Similarly, the second print unit contains engine imaging unit 20 which includes buffers or stack units 40.1 and 40.2. Imaging unit 20 feeds second print engine 26. Sheet 28 is fed initially into the first print engine 24 for the printing of side A, and subsequently after several print cycles enters the second print engine 26 for side B printing.

The basic printing process is as follows. The master 12 sends print data of sides A and B of sheet 28 to first and second engine imaging units 18 and 20. Each imaging unit proceeds to independently calculate the print identification data, for example a checksum, from the print data. The checksum calculated at the first engine imaging unit 18 is sent to the first print engine 24 and from there to the second print engine 26 through communications channel 22. The second print engine preferably stores the checksum received from the first print engine in a first of buffers 40.1 at the second engine imaging unit 20. The checksum calculated at the second engine imaging unit is likewise stored in a second of buffers 40.2 thereupon.

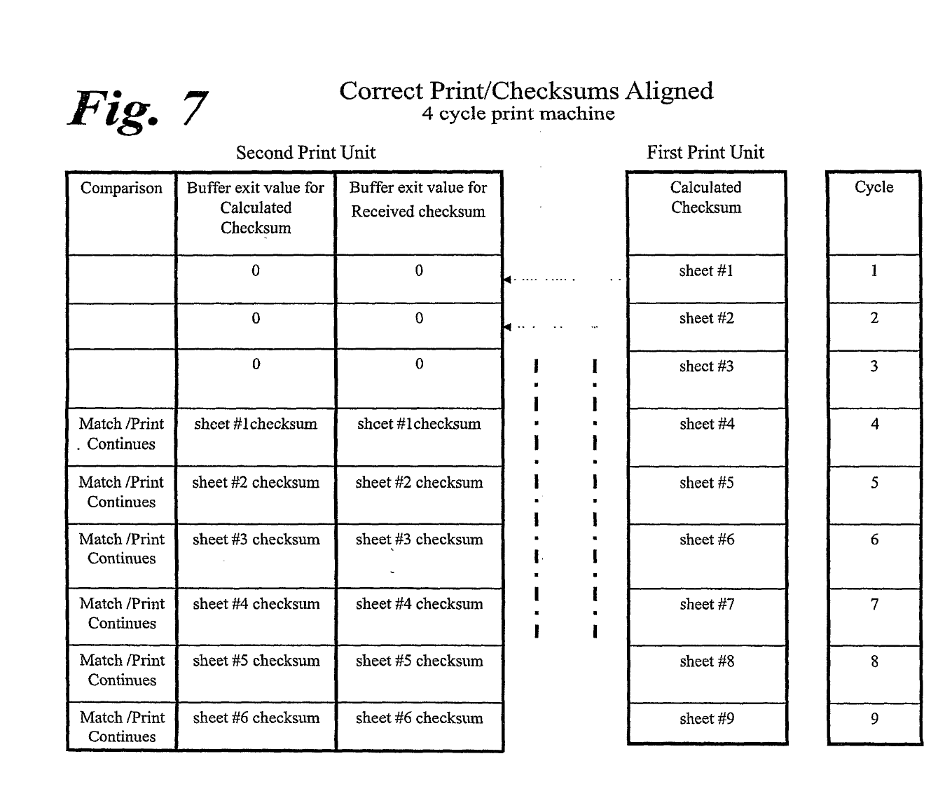

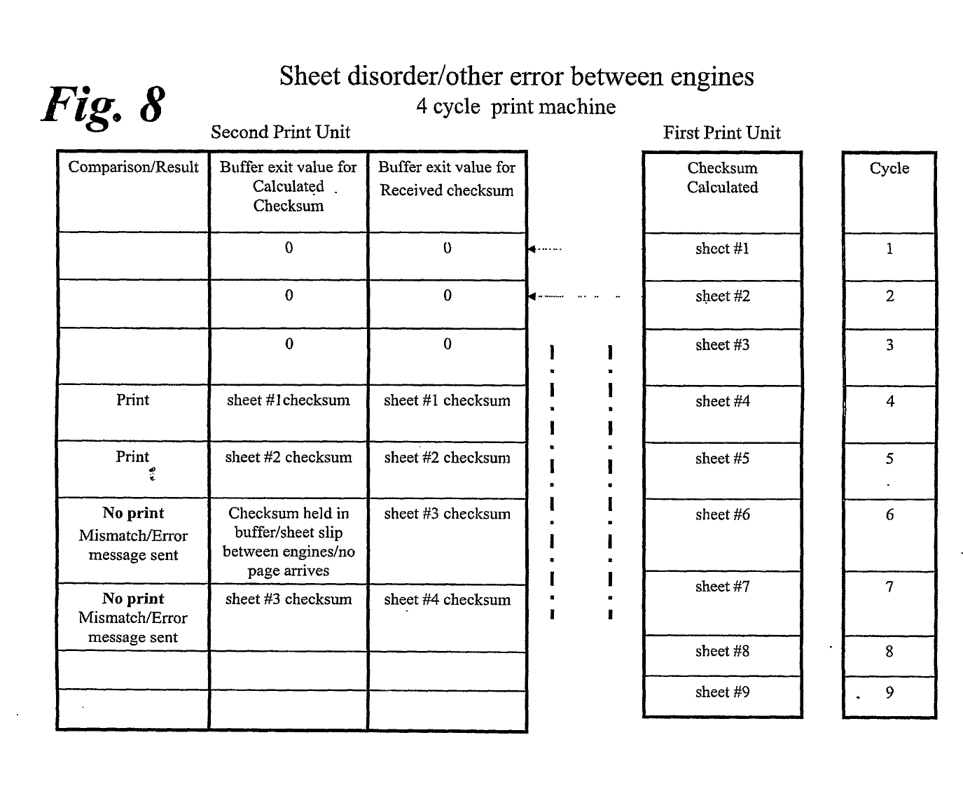

Buffer 40.1 may be a stack, containing slots to store the checksum values received from print unit 14. The buffer stack size may be set equal to the number of cycles it takes for the sheet to advance between the first and second print engines. For instance, in a machine that has 3 cycles between print engines (4 cycles in total), the last buffer slot or buffer exit value always contains the checksum of the page that printed 4 cycles prior at the first engine (See FIGS. 7 and 8). In other words, buffer 40.1 advances according to the print cycles of the machine.

On the other hand, second buffer 40.2 holding the checksum calculated at the second engine preferably advances only when a print occurs at the second print engine.

Now, the print data relating to side A print is sent from the first engine imaging unit 18 to the first print engine 24 for printing on incoming sheet 28. However, at second engine imaging unit 20, the print data is stored until sheet 28 arrives at the second engine 26. Upon completion of printing at the first print engine 24, the sheet 28 is flipped over and sent through the printer, reaching the second print engine 26 after a certain number of print cycles as explained in FIG. 1. When the page reaches the second engine, the second engine imaging unit carries out a comparison between the exit values of the two buffers described above, in other words, between the checksum or other print identification data received from first print unit 14 and the checksum or other print identification data calculated at the second engine imaging unit. If no page disorder occurs during the process, then the stacks advance in parallel and the exit checksums match (See FIG. 7). However, if the two checksums are not identical, an inference is made that a print disorder has occurred. The print machine operator is notified of a print disorder and the printing is stopped at the next print cycle.

Reference is made to FIG. 3, which is a simplified block diagram showing an alternative embodiment of the printer of FIG. 2. The buffers 40.1 and 40.2 are located on the second print engine 26 rather than on second imaging unit 20. Furthermore, communications channel 22 is a two way channel that connects between the first and second print engines, although in this particular embodiment data is sent in the direction from engine 1 to engine 2. The checksums or other print identification data are sent between the two engines directly and may be calculated at the engines themselves, for instance on engine firmware, rather than at the imaging units as described above.

Continuing with FIG. 3, the engine imaging units may send to each print engine a single string of data. The data string may contain the print job ID, print spread ID, print spread hierarchy, cycle number and repetition. The print spread IDs are sent as two separate numbers, one for each side of the sheet. The spread ID is set to −1 for non-production type print operations, for example no print, cleaner spread, special job and the like, where a comparison of the checksums is not necessary.

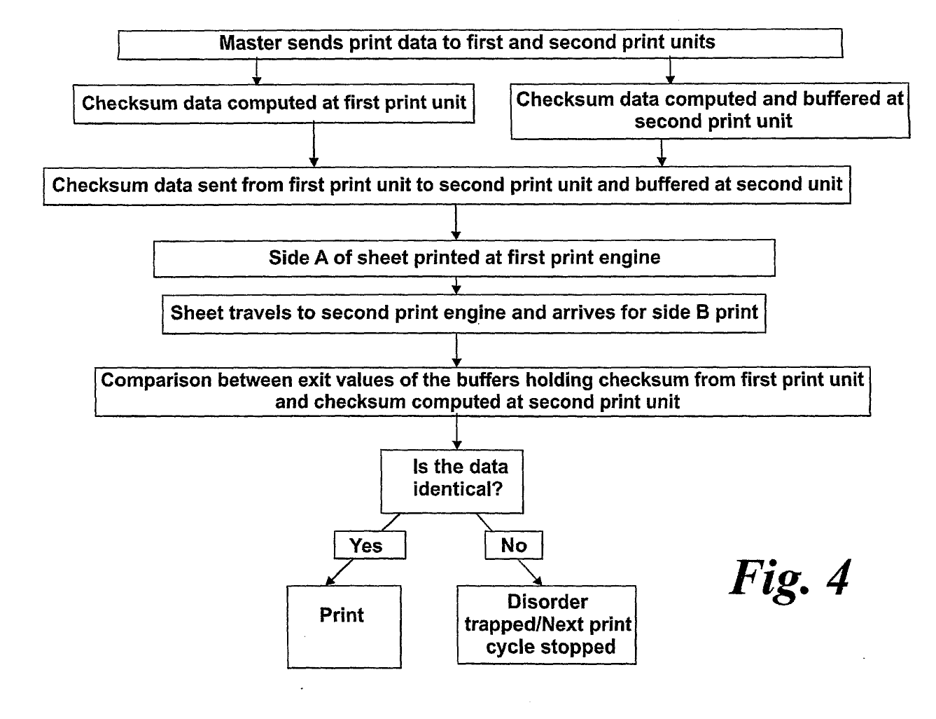

Reference is now made to FIG. 4, which is a simplified flow chart illustrating a print process according to an embodiment of the present invention. Initially, the master unit sends print data for both sides of the sheet to both first and second print units. The first and second print units use the print data to each calculate a checksum. The checksum computed at the first print unit is sent to the second print unit through a communication channel, for storage in a buffer. The checksum calculated at the second unit is stored in a different buffer therein. Side A of the sheet at the first print unit is printed at the first print engine therein. The sheet with side A printed then travels through the printer and reaches the second print engine on the second print unit for side B printing. The two buffer exit values are compared, one holding the checksum calculated at the second print and one received independently from the first print unit. If the two sets of data are not identical, an inference is made that a print disorder has occurred. The print machine operator is notified of the print disorder and the disorder is successfully trapped. The next print cycle is stopped. If the two sets of checksums are indeed identical, printing proceeds as normal.

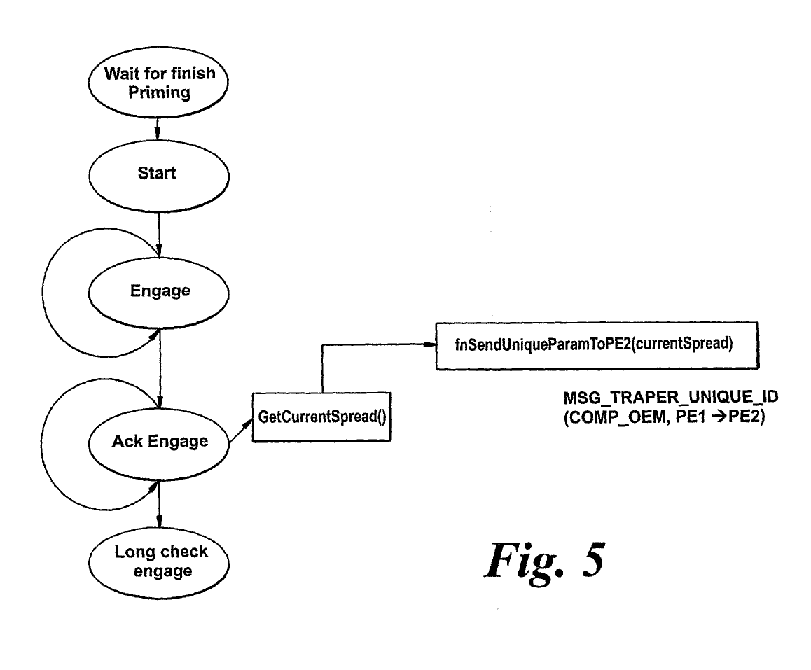

Reference is made to FIG. 5, which is a simplified flow chart illustrating the main steps in a print performed at the first print engine. First, the print unit primes the print heads and only then begins to start the print process. When a sheet enters the first print engine, a print engage occurs meaning that the physical process of printing side A of the print spread is begun. As soon as print engage is acknowledged by the first print unit, thereby notifying the master that the printing operation has begun, the first engine imaging unit calculates the checksum from the spread data. The first print unit then sends the print identification data, herein “unique parameters” to the second print unit. In the present embodiment, the print identification data is a checksum. However, other forms of print IDs may be used. In FIG. 5, the circle labeled “long check engage” refers to an end point of the printing cycle. The sheet now leaves the first print engine and travels a certain number of cycles to the second print engine.

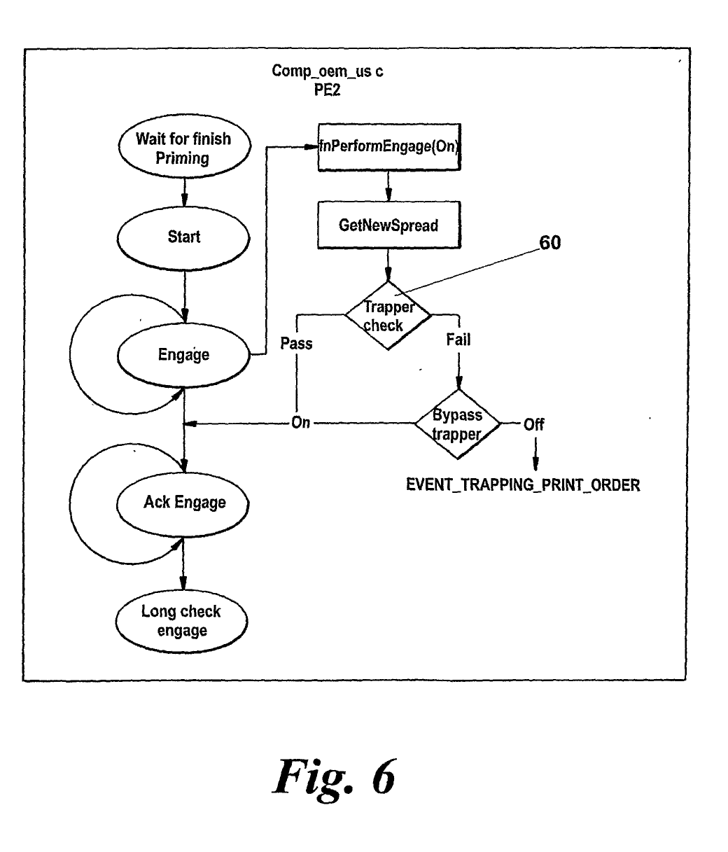

FIG. 6 is a simplified flow chart similar to FIG. 5 but representing instead the print operation at the second print engine. As in FIG. 5, the print unit primes the print heads and only then begins the print process. The calculation of the checksum at the second engine imaging unit is made at the same time as the calculation described in FIG. 5 regarding the first engine imaging unit. The calculation of the checksum at the second print unit is stored in a buffer that advances each time a sheet enters engine 2 and print engage occurs. After a sheet enters the second print engine, the comparison of the buffered checksum from the first print engine is made with the buffered checksum calculated independently at the second print engine. As shown in FIG. 6 a function “perform engage (on)” is provided for the controller to detect when print engage has begun. Once print engage is detected, the second engine imaging unit compares the two current buffer exit values. The comparison is carried out in trapper check stage 60. If the two checksums are not identical, a print disorder is assumed, and a fail notification is output. The print disorder is thus trapped, and the function proceeds to suppress the print acknowledgement. As a result of the non-appearance of the print acknowledgement, the next cycle of printing is suppressed. The possibility is provided within the function to override the fail output of the trapper and acknowledge engage. Such an override may be useful for tests or for print runs where sheet disorder is not of interest and is likewise seen in FIG. 6.

Reference is made to FIG. 7, which illustrates the case where a correct print on both sides of the sheet occurs and no disorder is detected. That is to say, at each print at the second print engine, the comparison between the buffer exit value of the sent checksum from the first print unit and the buffer exit value of the checksum computed at the second print unit shows a match. The figure represents a four cycle print machine, meaning it takes four clock cycles for the paper to print both sides of the page. The distance between the two print engines is thus three clock cycles. The buffer exit value remains 0 until the fourth cycle as will be explained below. The figure shows a print machine having four cycles for simplicity, but in practice the number may be set by the print frame size and twelve to sixteen print cycles is a typical range.

As shown in FIG. 7, at print cycle 1, a first sheet enters the first print engine and side A is printed. Before a print is completed at the first print engine, print identification data is calculated at the first print unit and sent to a buffer at the second print unit. In the present embodiment, a checksum is calculated as the print identification data, although other forms of print identification data are understood to be applicable. At the first print cycle, no sheet is at the second print engine and therefore no comparison of buffered checksums is carried out at the second engine imaging unit for this cycle. The two buffer exit values are 0 and remain as such until the fourth cycle. As previously explained, the buffer containing the sent checksum from the first print unit may be a stack containing four slots, equal to the number of print cycles of the print machine. The buffer exit value at any given cycle is the checksum sent four cycles prior from the first print unit. In contrast, the buffer containing the checksum computed at the second print unit only advances when a page enters the second print engine and a print actually occurs at the second print unit. At cycle 4, sheet #1 enters the second print engine for side B print. Before the print process, the checksums at the buffer exits are compared at the second print unit. At each print cycle, the two checksums match and therefore no print disorder is detected. Printing continues on at the next cycle.

Reference is made to FIG. 8, which is analogous to FIG. 7 but illustrates the case where a sheet disorder or other malfunction occurs while the page is traveling between the two engines. This figure shows how a page disorder is trapped as a result of communications between the two print units. During the print process at the first print engine, the respective checksums are calculated. The checksum at the first print engine is sent to the second print engine and stored thereupon in a buffer. The computed checksum at the second print engine is also stored thereupon in a separate buffer.

Now, at cycle position 6, sheet #3 does not arrive at the second print engine. This may be due to a number of reasons. The page may have slipped a cycle or even fallen off of the rollers entirely. The sheet may be stuck together with another sheet. In any case, as explained, the present embodiments attempt to identify and trap a print disorder whatever the reason may be.

Now, as explained above in FIG. 7, the buffer containing the sent checksum from the first print unit is preferably a stack containing four slots, equal to the number of print cycles of the print machine. This buffer exit value at any given cycle is the checksum sent four cycles prior from the first print unit. In contrast, the buffer containing the checksum computed at the second print unit only advances when a page enters the second print engine and a print actually occurs at the second print unit. Since no sheet arrives at cycle 6, no print occurs. The second engine imaging unit 20 holds the print data in a queue and a print engage does not occur. The buffer holding the checksum computed at the second print unit does not advance. However, the buffer exit value for the sent checksum is the checksum of sheet #3. When a comparison is carried out between the buffer exit values, a mismatch occurs. At the next print cycle, cycle 7, a sheet arrives, which may or may not be sheet #3. Side B of the sheet #3 spread is printed and the sheet #3 checksum is at the exit of the buffer containing the second engine computed checksum. The buffer exit value for the sent checksum has now advanced one slot, namely the checksum for sheet #4. As explained, the exit value for this buffer is always the checksum of the sheet that entered the first engine 4 cycles prior. So again, when the checksums are compared, a mismatch is found and an error message is sent to the operator. The printing is stopped at the next cycle.

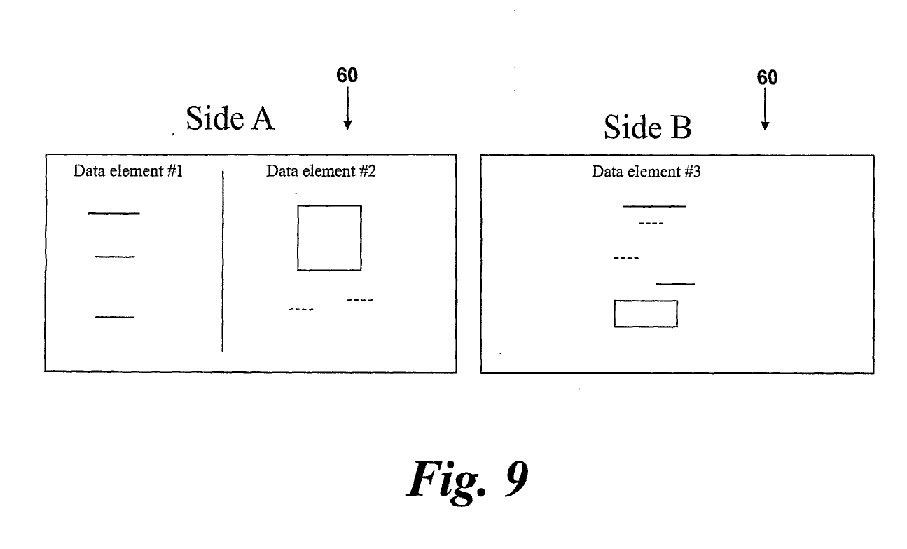

Reference is now made to FIG. 9. FIG. 9 shows a sheet 60 and schematically shows print data sent from the master as in the previous embodiments. In the present embodiment the print data is made up of elements, the elements dividing up the print data into convenient modules to assist with data compression and printing efficiency. In an example, different types of print data, say text image data, are split into separate elements. Each element for example has a header that provides information such as the type of data, the encoding scheme and where it should be placed in the layout. FIG. 9 shows sheet 60 with print data arranged into three different data elements. Side A has data elements 1 and 2. Side B has an additional data element, 3. As said, each element may represent a different data type, such as text data or graphics data. Further, each element has associated print content data in addition to a header. The print content data contains the actual or compressed print content that is used to operate the printer.

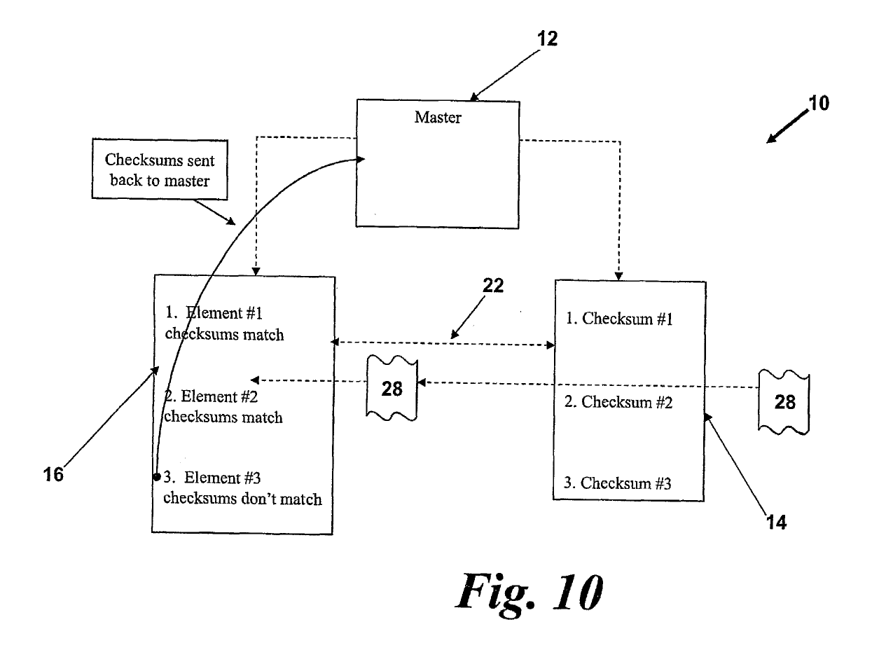

Reference is made to FIG. 10, which is a schematic view of a particular embodiment of the present invention, used to illustrate what happens when the print data elements seen in FIG. 9 are sent from the master as explained below. The actual structure of the print machine seen in FIG. 10 is analogous to that shown in FIGS. 1 and 2. For a given spread, the master sends all the print data for both sides of the sheet to both print units 14 and 16, as in the previously described embodiments. However, in this embodiment, before print engage at the first print engine, both print units compute individual print identification data for each element on the sheet. An example of the print identification data is a computed checksum. Another example of print identification data is simply to make direct use of the data in the element headers. Whether element headers, checksums, or other types of print identification data are used, the point to be understood is that a signature of the data, but not the data itself, is transferred between the two engines. This is because the communication channel is not of sufficient bandwidth to support the transferring of an entire data file between the engines. However, as mentioned above, merely sending say an identification number of the print data, would not catch data corruption on one of the printed sides. Rather the present embodiments teach the obtaining of an identification of the data itself, through a signature of the data, and send the signature between the engines.

In FIG. 10, the print data for both sides contains three checksums representing three different data elements. As stated, before print engage at the first engine 14, the first engine sends, through channel 22, the element checksums to the second engine 16. In an alternative embodiment, the second engine 16 may send the element checksums to the first engine 14. In the present embodiment, the second print unit now contains two sets of element checksums, and proceeds to compare the two sets. As shown in FIG. 10, the element #1 checksum and the element #2 checksum in each set match. However, the element #3 checksum in each set does not match. The second print unit sends the element #3 checksum in each set back to the master for a check. The master then checks the received checksums by computing itself the checksum of element #3 and comparing the result to each of the received checksums. After determining which of the received checksums is corrupt, the master knows which engine received the corrupt print data, and proceeds to resend a correct version of the print element in question to this engine. Once the correct print data is received at the print engine which previously received the corrupt data, a print proceeds at the first engine as described in the above embodiments. To check print disorder, the embodiments described in FIG. 1 to 8 may be applied to the present embodiment.

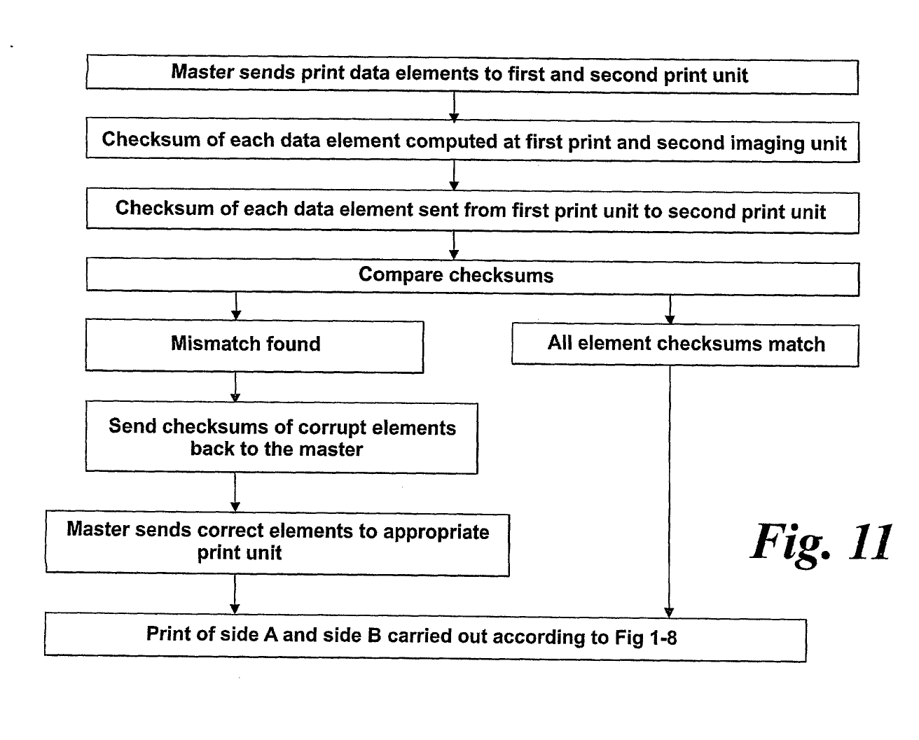

Reference is made to FIG. 11, which is a simplified flow chart illustrating the print process described in FIG. 10. The master sends print data elements to the first and second print unit. A checksum of each data element is computed at both the first and second engine imaging unit. Next, the checksums are sent from the first print unit to second print unit. The checksums are compared. If a mismatch is found, the second engine imaging unit returns the checksums that do not match back to the master. The master then checks the received checksums by doing its own checksum computation of the returned element and comparing this checksum to each of the received checksums. After determining which of the received checksums is corrupt, the master knows which of the engines received the corrupt print data. The master then resends a correct version of the data element to the appropriate engine. A mismatch of checksums indicates a corruption of one or both of the print elements which was used to calculate the checksums. The master thus checks the checksums and sends correct elements to the print unit which received the corrupt element.

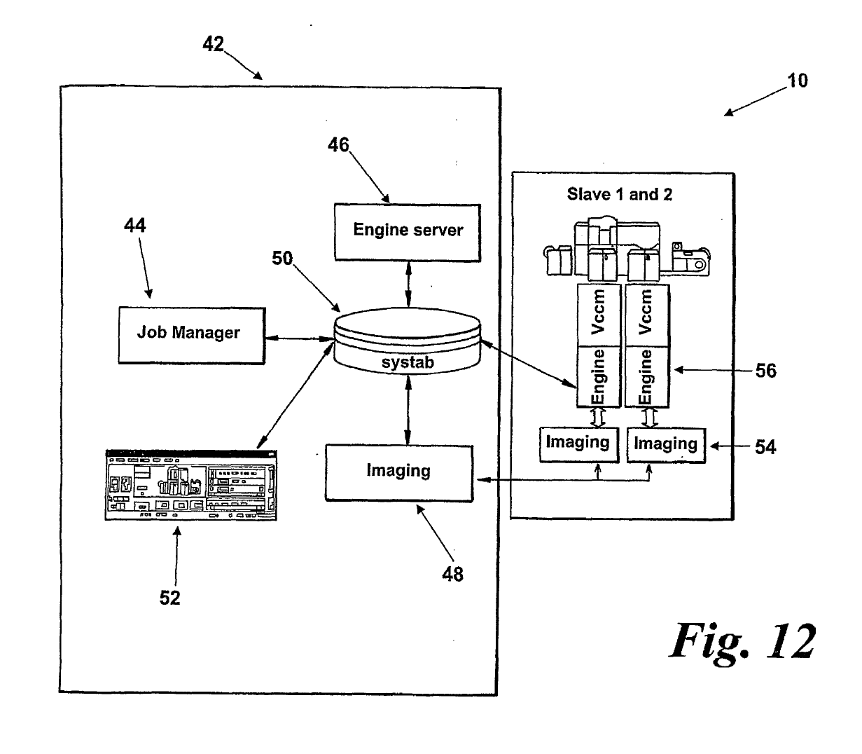

Reference is made to FIG. 12, which is a system overview of the dual engine print machine 10 of FIGS. 1 and 2. In FIG. 12, master unit 42 comprises several elements. The job manager 44 sends to the engine 46 and imaging 48 servers the print data through central router 50. An operator PC based interface 52 is connected through central router 50 and allows for a user friendly operation of the print machine 10. The imaging units 54 receive the print data from the imaging server 46 and feed data to the engines. The engines 56 also receive engine specific information from the engine server 46 through central router 50.

As can be seen from the above description, sheet disorder may be detected and trapped irrespective of the cause, unlike the prior art which looks for specific causes. In the present embodiments, the cause of the disorder or data corruption makes little difference. Therefore, problems are solved for the sort of customers who do not have access to technical support from the manufacturer or who merely have limited access, often customers of customers or customers at geographically isolated locations. Alternatively the detection system can be used to manage the problem until maintenance or can be used to provide troubleshooting data which may be of help to the maintenance engineer.

Further, the issue that arises here is part of the general and well known problem of interfaces between the real world and the digital world, here between the worlds of feeding sheets of paper and feeding data. A check needs to be done after the print of side A by the printer for side B so that a physical or mechanical failure between the engines does not go unnoticed. Likewise, even a data error that is passed to either or both of the engines from the master will lead to a misprint. In this case, the comparison between the two engines gives the human operator a second measure of confidence in the printing integrity of the machine.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A dual engine printer comprising a first print engine and a second print engine, wherein identical spread data is forwarded to each of said print engines, each print engine comprising a signature extractor for extracting a signature representative of at least part of said spread data, and said apparatus being configured to compare said signatures to output a verification result to verify that said at least part of said spread data is identical.

2. Apparatus according to claim 1, comprising a data link between said first and second print engines, through which to forward one of said signatures for comparison with the other of said signatures.

3. Apparatus according to claim 1, wherein a given sheet is printed on respective sides at each engine over the course of a predetermined number of cycles, each cycle beginning with a print engage operation, and wherein said comparing is synchronized with said print engage operations, thereby to trap print disorder.

4. Apparatus according to claim 1, wherein said spread data comprises data elements and wherein said signatures are generated per data element, thereby to verify that identical data elements are present at each print engine.

5. Apparatus according to claim 4, further configured such that when it is determined that respective signatures are different, a determination is made as to which engine has a corrupt element, and a correct element is sent to replace said corrupt element.

6. Apparatus according to claim 1, wherein said signatures comprise check sums of at least part of the spread data.

7. In a dual engine printer having a first print engine and a second print engine, each engine printing respective sides of a plurality of sheets in dual sided printing where print data of both sides of said sheets is received at both engines, a method for detecting an inconsistency between printing at said first print engine and at said second print engine, the method comprising:
generating first identification data from said print data for a respective sheet in association with said first print engine,
independently generating second identification data from said print data for a respective sheet in association with said second print engine, and
at a time of presumed printing of said respective sheet at said second print engine, comparing said first identification data with said independently generated second identification data to verify that a second side is being printed on said respective sheet.

8. The method of claim 7, further comprising exchanging said identification data through a communications channel connecting said first print engine and said second print engine.

9. The method of claim 7, wherein said identification data comprises a checksum.

10. The method of claim 7, comprising buffering said first identification data at said second engine for a number of print cycles equal to a travel time of a sheet from said first engine to said second engine.

11. The method of claim 7, wherein said second engine aborts printing if said inconsistency is found.

12. The method of claim 7, wherein respective engine imaging devices associated with said first and second print engines generate said first and second identification data.

13. The method of claim 12, wherein first said engine imaging device provides said first identification data to said second engine imaging device.

14. The method of claim 7, wherein said comparison is carried out only when a said respective sheet enters said second print engine for printing.

15. (canceled)

16. A method for dual sided printing using first and second print engines for printing of respective sides of a dual sided sheet, print data for both sides of said sheets being received at engine, said print data comprising a plurality of print elements, the method comprising:
independently generating at each engine respective identification data for said print elements
comparing said respective identification data of corresponding said print elements; and
resending any element found not to be identically received at both engines.

17. The method of claim 16, further comprising exchanging said identification data through a communications channel connecting first and second print engines.

18. The method of claim 16, wherein said elements comprise element headers and wherein said identification data comprises respective element headers.

19. (canceled)

20. The method of claim 16, wherein if said comparison results in a mismatch, said identification data of corresponding elements is sent to a master unit which sends at least one corrected element to at least one of said engines which had previously received corrupt data.

21. The method of claim 20, wherein said first engine delays printing until said corrected print element is received.

22. The method of claim 16, wherein said first and second print engines each comprise respective controllers and wherein said respective controllers are configured to generate said identification data.

23-25. (canceled)
